(19) United States
(12) Patent Application Publication
(10) Pub. No.: US 2023/0286351 A1
(43) Pub. Date: Sep. 14, 2023

(54) REFRIGERATION DUCT SYSTEM FOR A TRANSPORTATION REFRIGERATION UNIT

(71) Applicant: Smart Cooling Advanced Cooling Systems Ltd., Moshav Mishmeret (IL)

(72) Inventor: Igal BECK, Hadera (IL)

(73) Assignee: Smart Cooling Advanced Cooling Systems Ltd., Moshav Mishmeret (IL)

(21) Appl. No.: 17/999,820

(22) PCT Filed: May 26, 2021
(86) PCT No.: PCT/IB2021/054611

§ 371 Date: Nov. 23, 2022

Related U.S. Application Data
(60) Provisional application No. 63/030,322, filed on May 27, 2020.

(51) Int. Cl. B60H 1/00; B60H 1/24; B60H 1/34

(52) U.S. Cl. CPC B60H 1/00564; B60H 1/00364; B60H 1/245; B60H 1/3407

(57) ABSTRACT

A refrigeration duct system configured for use in a transportation vehicle having a cargo space and a refrigerator unit, the cargo space having a ceiling and cargo doors at a rear end thereof. The refrigeration duct system includes an elongated refrigeration duct disposed adjacent to the ceiling of the cargo space having a proximal end and a distal end, the refrigeration duct including a plurality of cold air outlets arranged along the length of the duct in which each of the cold air outlets has a downstream edge transverse to the refrigeration duct. The duct also includes a plurality of curved flaps operably connected respectively to at least some of the plurality of cold air outlets at the downstream edge of the cold air outlets in which the curved flaps are configured to direct cold air from the refrigerator unit in a downward direction.

### FIELD OF THE INVENTION

The invention relates to refrigeration, in particular to a refrigeration duct system, especially useful for transportation vehicles carrying temperature-sensitive foods, for example refrigerated trailer trucks and the like.

### BACKGROUND OF THE INVENTION

It is a challenge to preserve food in refrigeration trailer trucks, especially with numerous deliveries on hot days.

It is believed that the current technology is disclosed in the following publications: US 10,434,841 (Ertel, et al., 2019-10-08); US 2017/059227 (Balakrishna, et al., 2017-03-02); US 6,508,076 (Gast et al., 2003-01-21); US 9,636,967 (Clark, 2017-05-02); US 2012/198866 (Zeidner, 2012-08-09); FR 2983127 (Aubert et al., 2013-05-31); and TWM328967U (Fan, 2008-03-21).

### SUMMARY OF THE INVENTION

The present invention provides a refrigeration duct system for a refrigeration unit that provides an improved temperature gradient between a trailer truck interior space (cargo space), or the like, and the outside ambient atmosphere. Additionally or alternatively, the refrigeration duct provides improved refrigerated air circulation within the cargo space.

The refrigeration duct system is configured for use in a transportation vehicle having a cargo space and a refrigerator unit, the cargo space having a ceiling and cargo doors at a rear end thereof.

The refrigeration duct system includes an elongated refrigeration duct disposed adjacent to the ceiling of the cargo space having a proximal end and a distal end, the refrigeration duct including a plurality of cold air outlets arranged along the length of the duct in which each of the cold air outlets has a downstream edge transverse to the refrigeration duct. The duct also includes a plurality of curved flaps operably connected respectively to at least some of the plurality of cold air outlets at the downstream edge of the cold air outlets in which the curved flaps are configured to direct cold air from the refrigerator unit in a downward direction.

In some designs, each of the plurality of curved flaps is respectively associated with one of the cold air outlets. In some designs, each of the plurality of curved flaps is respectively associated with 40% - 60% of the cold air outlets. In some designs, each of the plurality of curved flaps is respectively associated with every other one of the cold air outlets. In some designs, the plurality of curved flaps is arranged diagonally. In some designs, the plurality of curved flaps is arranged in alternate rows.

In some designs, the duct includes an elongated strip with an arch-shaped portion disposed at or near the distal end of the duct and configured to direct the cold air downwards.

In some designs, the system includes at least one fan disposed at the distal end of the refrigeration duct and configured to blow air downward. In some designs, the at least one fan is spaced apart from the rear end of the cargo space. In some designs, there is a plurality of fans arranged transversely with respect to the refrigerator duct.

It is a particular feature of the present refrigeration duct system that it includes a plurality of cold air outlets in which at least some have an associated curved flap to direct the cold air generally downward. The curved flaps are attached to respective cold air outlets or portions thereof, at the far (downstream) edge thereof. Without limitation to theory, it is believed that this design provides a suitable air circulation as well as temperature uniformity within the cargo space and/or an improved (higher) temperature gradient between the cargo space and the ambient/exterior. In other words, the present refrigeration duct system is configured to preserve a suitable temperature in the truck interior/cargo space and minimizes heat exchange between the interior and exterior space even when the trucks hatch or doors are opened during loading and unloading of deliveries, such as foodstuffs.

It is another particular feature of the present refrigeration duct system that it further includes a distal strip at the distal end of the duct that is also configured with a curved portion in order to direct air downward.

### BRIEF DESCRIPTION OF THE DRAWINGS

The invention may be more clearly understood upon reading of the following detailed description of non-limiting exemplary embodiments thereof, with reference to the following drawings, in which:

FIG. 1 is a plan view of a refrigeration duct system for a transportation refrigeration unit in accordance with embodiments of the present invention, operably connected to the ceiling of a refrigeration truck trailer - along with an exploded enlarged view of a refrigeration unit associated therewith; and a side view of an elongated end-flap thereof.

FIG. 2 is substantially a side view of FIG. 1, along with an end view thereof.

FIG. 3 is a plan view of an alternately designed refrigeration duct system in accordance with embodiments of the present invention.

FIG. 4 is a perspective view of a portion of the refrigeration duct system illustrating an exemplary cooling air flap arrangement.

FIGS. 5-7 are perspective views of a portion of the refrigeration duct system illustrating another exemplary cooling air flap arrangement.

FIGS. 8-9 are respective perspective and side views of the elongated end-flap depicted in FIG. 1.

FIGS. 10-11 are respective perspective and side views of an exemplary cooling air flap of the system.

FIG. 12 is a perspective view of ducting of the system of FIG. 1.

FIG. 13 is a view from the end of the cargo space.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DESCRIPTION OF EMBODIMENTS OF THE INVENTION

Identical, duplicate, equivalent or similar structures, elements, or parts that appear in more than one drawing are generally labeled with the same reference numeral, optionally with an additional letter or letters for reference to particular objects. Dimensions of components and features shown in the figures are chosen for convenience or clarity of presentation and are not necessarily shown to scale or true perspective. For convenience of clarity, some elements or structures may not be shown or shown only partially or with different or without perspective, and duplicate or equivalent or similar parts may not be repeatedly labeled and/or described.

The following description relates to one or more non-limiting examples of embodiments of the invention. The invention is not limited by the described embodiments or drawings, and may be practiced in various manners. The terminology used herein should not be understood as limiting unless otherwise specified.

The figures show embodiments of a refrigeration duct system for a trailer truck refrigeration unit.

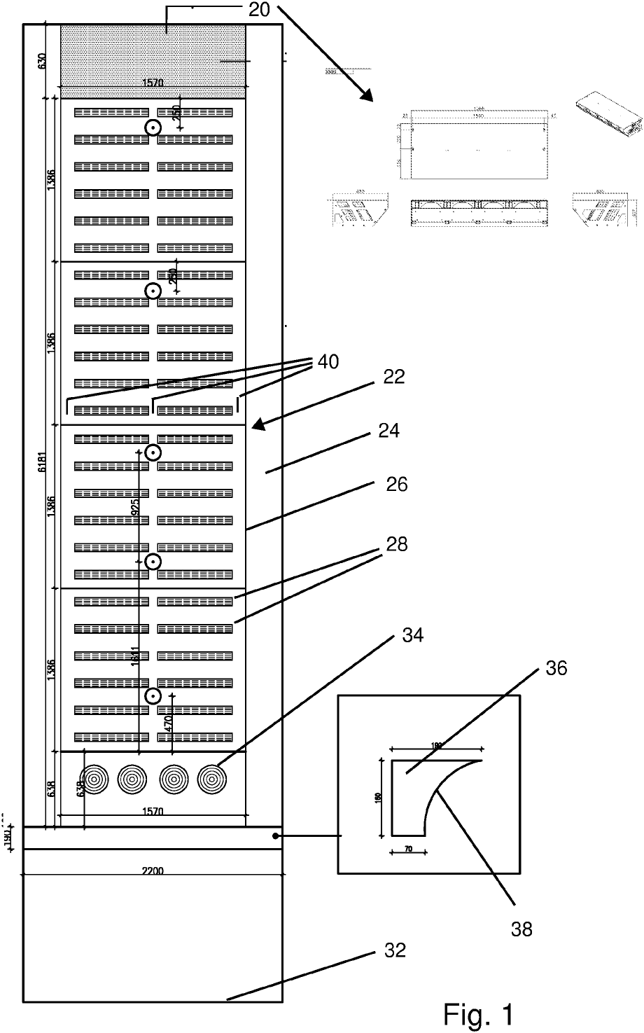

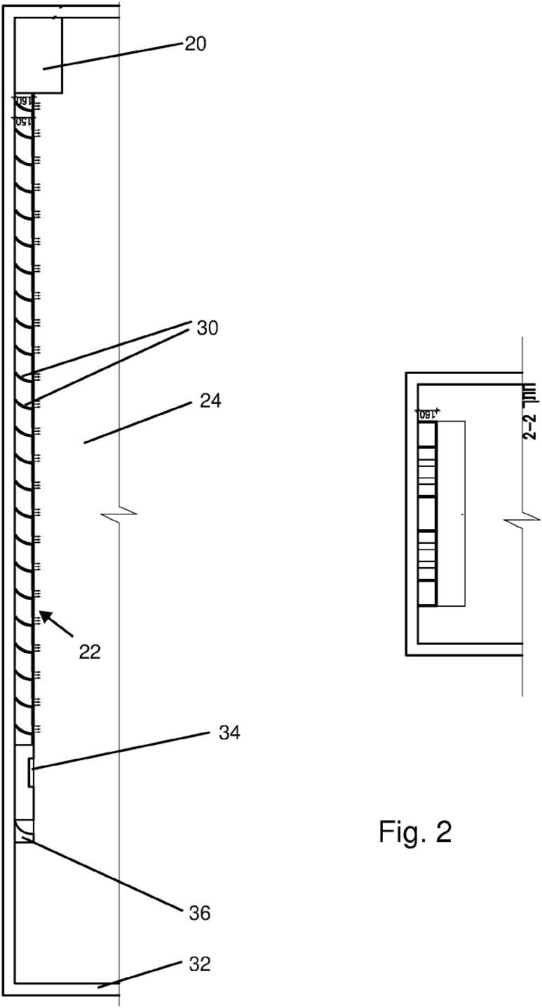

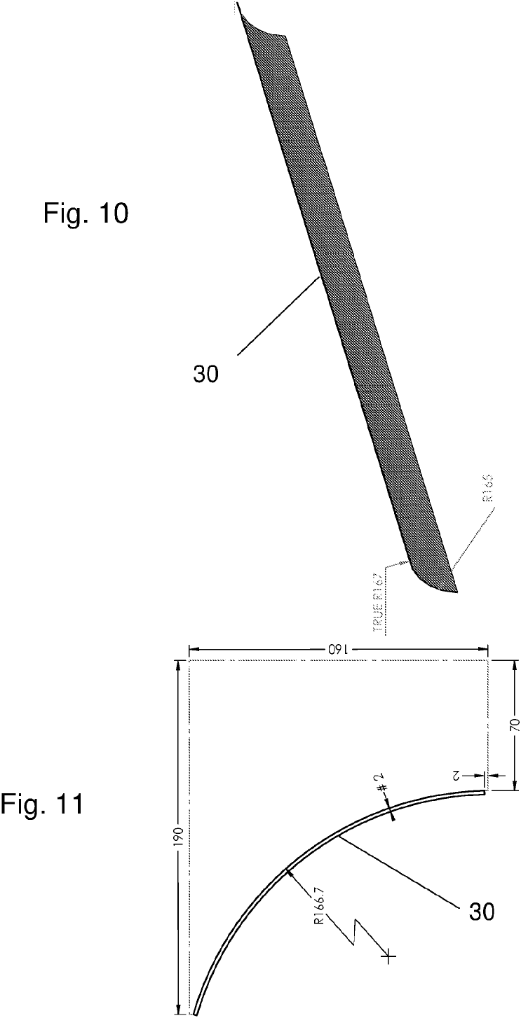

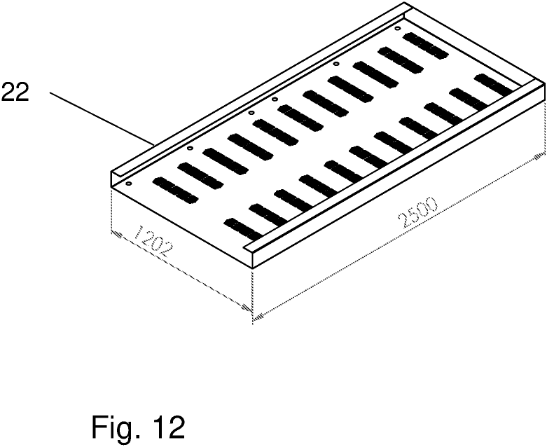

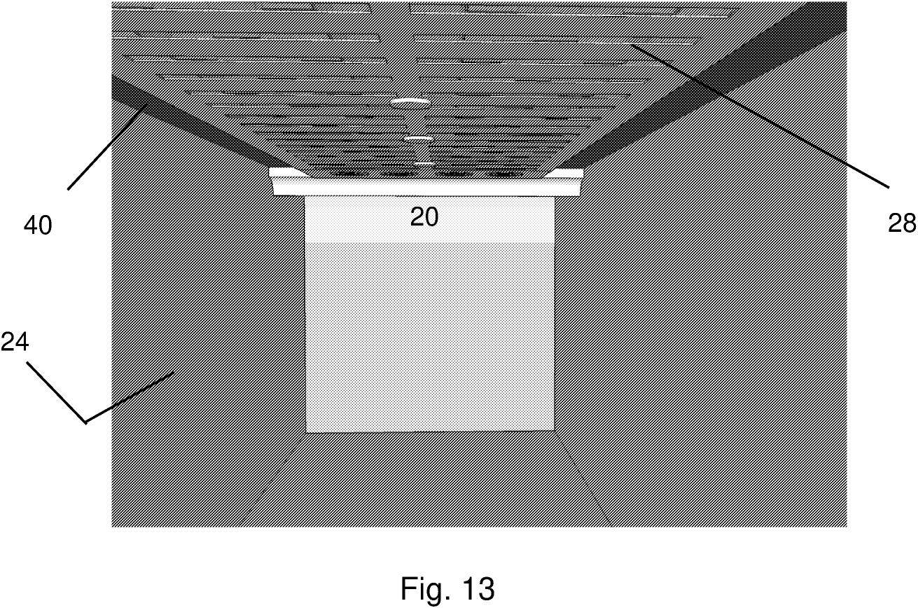

FIGS. 1-2 are partial views of a truck refrigeration cargo space 24 (a more complete view is shown in FIG. 13) of a refrigeration trailer truck, viewing in an upward direction toward the roof thereof and a side view, respectively. A refrigeration cooling unit 20 is configured and arranged to expel cold air to a refrigeration duct 22 (see also FIG. 12), which is adjacent the roof of cargo space 24. Cooling unit 20 may be a standard cooling unit and thus will not be further described. Refrigeration duct 22 receives cold air from cooling unit 20 and has a rectangular box shaped air-flow passage 26 with a plurality of spaced apart cold air outlets 28 (exemplified by two columns of such outlets with twenty four air outlets in each column). Cold air outlets 28 are located in the bottom of passage 26 and may be rectangularly shaped and uniformly distributed, as illustrated. Attached to the downstream side of each air outlet 28 is a curved air-directing flap 30 (FIGS. 2, 10 and 11) configured to direct cold air downward, due to the curvature of the flap. In some designs, flap 30 has a curvature consistent with a minor arc of a circle; and that curvature may, for example, have a radius of curvature of 15-18 cm.

The proximal end of duct 22 is configured to interface with and receive cold air from cooling unit 20. The distal end of duct 22 is generally adjacent the hatch/doors 32 of cargo space 24. Duct 22 is typically mounted to the roof of cargo space 24.

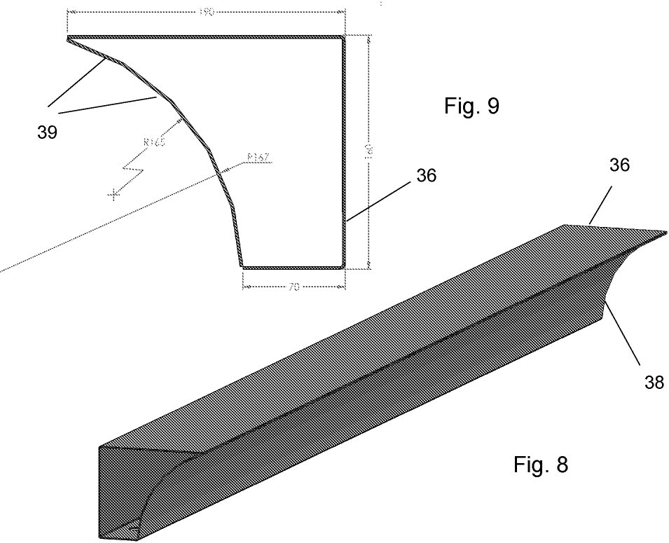

At the distal portion of duct 22, toward the rear cargo doors (or hatch) of cargo space 24 where truck contents are loaded and unloaded, are fans 34, illustrated by four fans. At the distal end of duct 22, just distal to where fans 34 are housed, is an elongated strip 36 with an arch-shaped portion 38 that is also configured to direct cold air downward due to its arched shape. Strip 36 is typically spaced apart from the rear cargo hatch/doors, for example by about 1.5 meters. FIG. 8 shows a perspective view of elongated strip 36 with arch-shaped portion 38; and FIG. 9 shows that the arch can be constituted by a plurality of angled flat sub-portions 39.

The top of duct 22 may be constituted by the roof of cargo space 24, in which the duct has a generally elongated U-shape and has means to be fastened to the cargo space roof.

When cooling unit 20 is operating, cold air exits therefrom and enters the proximal end of duct 22. A portion of the cold air exits from each of cold air outlets 28 of duct 22. Typically there are margins 40 at the sides and between any columns of air outlets 28 where cold air can flow so as to help to evenly distribute cold air to each of air outlets 28 and limit air flow resistance. Cold air can also flow within duct 22 above (passed) the “initial” air outlets 28 to thereby aid in evenly distributing the cold air amongst the air outlets.

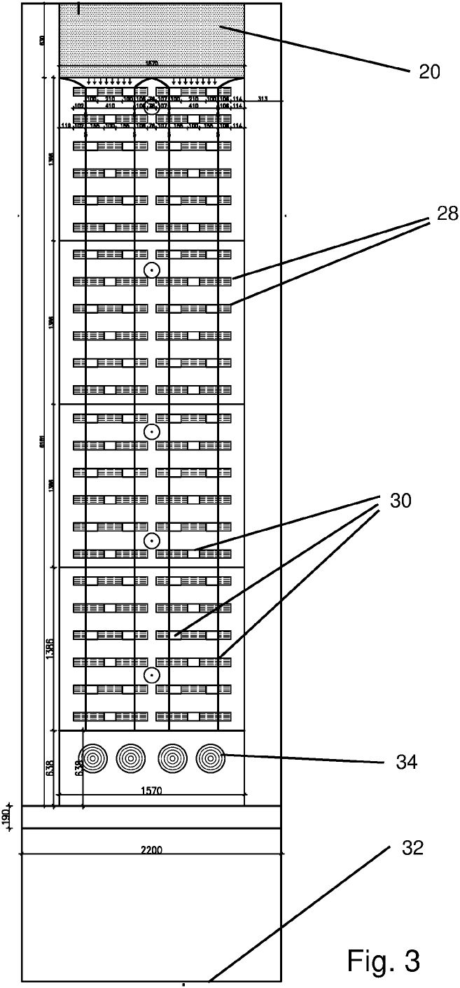

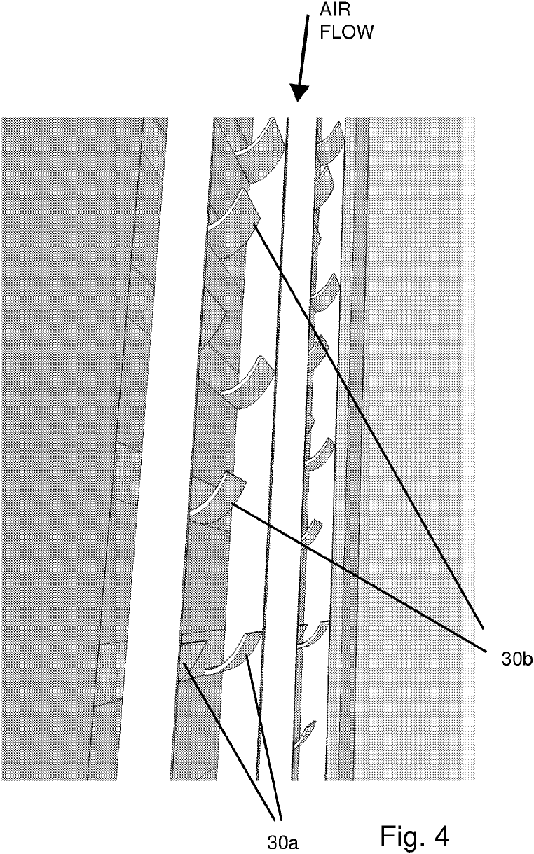

FIGS. 3-4 illustrate another exemplary design of refrigeration duct 22 wherein air-directing flaps 30 are arranged at particular locations of air-directing outlets 28. In this design, every other air outlet 28 has a pair of air-directing flaps 28a spaced apart from each other and near, but not at, the sides of the outlets (illustrated at the air outlets adjacent cooling unit 20; FIG. 3). The “other” every other air outlets 28 have one air-directing flap 30b located in the middle of the far edge thereof (illustrated at the air outlets adjacent fans 34; FIG. 3).

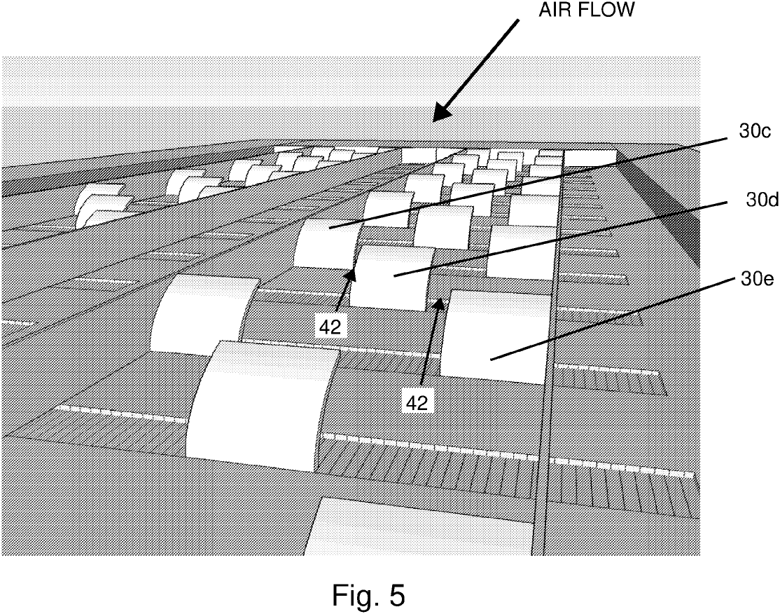

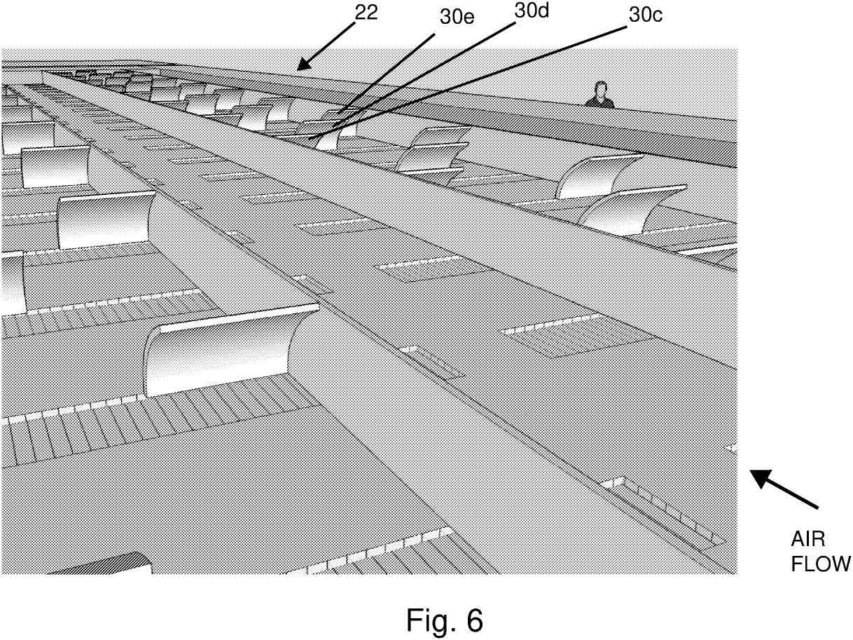

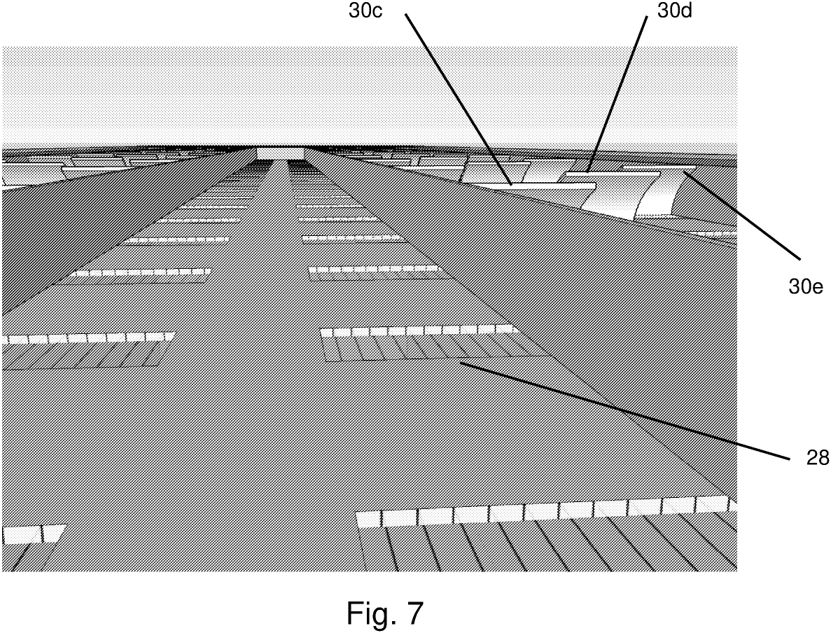

FIGS. 5-7 show another exemplary design of refrigeration duct 22 wherein air-directing flaps 30 are arranged in a stepped arrangement. In other words, as seen, at one air outlet 28, a left-side flap 30c descends from the far end of one side of the outlet, and extends along about a fourth of the width of the outlet. The subsequent air outlet 28 has a central flap 30d descending from the far end of the central portion of the outlet, and extends along about a fourth of the width of the outlet. The next subsequent air outlet 28 has a right-side flap 30e descending from the far end of the outlet at the opposite side of the outlet as flap 30c, and also extends along about a fourth of the width of the outlet. As such, there are air passageways 42 on either side of central flap 30d for air to pass.

Without limitation to theory, the present refrigeration duct may produce, at least partially, the well-known air-curtain effect, and in fact a plurality of air-curtains, so as to aid in reducing heat exchange between the cargo container and the exterior. Additionally, and without limitation to theory, the particular designs and positions of the flaps contribute to a high degree of cool air mixing resulting in an improved (reduced) temperature gradient within the cargo space; i.e. relatively even cooling and temperature.

Although the invention has been described with reference to trucks, it should be understood that the invention can be suitably implemented with other refrigerated transport vehicles such as train box-cars, shipment containers, and the like.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A refrigeration duct system for a transportation vehicle having a cargo space and a refrigerator unit, the cargo space having a ceiling and cargo doors at a rear end thereof, the duct system comprising:
an elongated refrigeration duct disposed adjacent to the ceiling of the cargo space having a proximal end and a distal end, the refrigeration duct comprising a plurality of cold air outlets arranged along the length of the duct in which each of the cold air outlets has a downstream edge transverse to the refrigeration duct; and
a plurality of curved flaps operably connected respectively to at least some of the plurality of cold air outlets at the downstream edge of the cold air outlets in which the curved flaps are configured to direct cold air from the refrigerator unit in a downward direction.

2. The system as claimed in claim 1, wherein each of the plurality of curved flaps is respectively associated with one of the cold air outlets.

3. The system as claimed in claim 1, wherein each of the plurality of curved flaps is respectively associated with 40% - 60% of the cold air outlets.

4. The system as claimed in claim 1, wherein each of the plurality of curved flaps is respectively associated with every other one of the cold air outlets.

5. The system as claimed in claim 1, wherein the plurality of curved flaps is arranged diagonally.

6. The system as claimed in claim 1, wherein the plurality of curved flaps is arranged in alternate rows.

7. The system as claimed in claim 1, wherein at least some of the flaps of the plurality of curved flaps have a curvature consistent with an arc of a circle.

8. The system as claimed in claim 1, wherein the arc of the circle has a radius of curvature of 15-18 cm.

9. The system as claimed in claim 1, wherein the air outlets are spaced apart.

10. The system as claimed in claim 1, comprising an elongated strip with an arch-shaped portion disposed at or near the distal end of the duct and configured to direct the cold air downwards.

11. The system as claimed in claim 1, comprising at least one fan disposed at the distal end of the refrigeration duct and configured to blow air downward.

12. The system as claimed in claim 11, wherein the at least one fan is spaced apart from the rear end of the cargo space.

13. The system as claimed in claim 11, wherein there are a plurality of fans is arranged transversely with respect to the refrigerator duct.
